(19) United States
(12) Patent Application Publication
(10) Pub. No.: US 2010/0063639 A1
(43) Pub. Date: Mar. 11, 2010

(54) Methods and Systems for Applying and Monitoring Multiple Chemical Treatments in Gas Wells

(75) Inventor: Edward J. Gothard, Crescent, OK (US)

Correspondence Address: JACKSON WALKER LLP, 901 MAIN STREET, SUITE 6000, DALLAS, TX, 75202-3797, US

(73) Assignee: Multi-Chem Group, LLC, San Angelo, TX (US)

(21) Appl. No.: 12/506,783

(22) Filed: Jul. 21, 2009

Related U.S. Application Data
(60) Provisional application No. 61/135,591, filed on Jul. 22, 2008.

(51) Int. Cl. G05D 7/06; G05B 19/05

(52) U.S. Cl. 700/282

(57) ABSTRACT

Methods and systems for enhanced gas recovery, including remote, automated, or manual monitoring, control and coordination of multiple of treatments administered to remote gas well. Treatments administered may include deliquification, demulsification, scale inhibition, paraffin inhibition, corrosion inhibition, water clarification, and H₂S scavenging. The apparatus incorporates a variety of equipment and chemicals for carrying out a variety of automated treatments and uses numerous meters and sensing devices for monitoring and controlling treatments by a programmable logic controller (“PLC”) computer. The PLC is accessed remotely to provide real time monitoring and control of well performance and treatment.

This application claims priority to U.S. Provisional Patent Application Ser. No. 61/135,591 entitled “Methods and Systems for Applying and Monitoring Multiple Chemical Treatments in Gas Wells,” filed on Jul. 22, 2008, the entire content of which is hereby incorporated by reference.

### BACKGROUND

The systems and methods described herein pertain to the production of natural gas, enhanced gas recovery, the deliquification of gas wells, and particularly to an automated system and apparatus for monitoring and treating gas wells during production.

Numerous processes, treatments, measurements, and calculations go into the monitoring and maintenance of a producing gas well. Well performance is affected, both negatively and positively, by a number of factors. Staying on top of all of these considerations requires time and investment.

An obstacle faced in the lifetime of many gas wells is a phenomenon known as “liquid loading.” Liquid loading occurs when the produced gas is not able to remove produced liquids, usually water, from the well bore. When this happens, the produced liquids accumulate in the well bore, causing a decrease in production and a decrease in the length of time during which the well will successfully produce gas. Thus, it is useful to both timely recognize liquid loading when it occurs in a producing gas well and to deliquify the well in order to restore it to its normal production level.

If liquid loading can be detected early, expensive losses in gas production can be avoided. Some indications that might suggest that a well is liquid loading include spikes in orifice pressure, erratic production, a distinct change in pressure gradient, or the cessation of liquid production. Nevertheless, continuous monitoring for the presence of one or more of these indicators and prompt resolution of the reasons for the loss of production may be impractical due to time and expense.

The deliquification of gas wells has been addressed in the industry by various approaches throughout history. Siphons and accompanying equipment, such as gas-lift valves and timing devices, relieve this problem where water production is profuse. However, such systems are expensive and sometimes not cost justified for marginal wells or those that produce only a little water. Although bailing and swabbing usually will remove the liquids from such wells, these practices are also relatively expensive and time consuming for some wells. Other approaches to the deliquification of gas wells include velocity strings, plunger lift, pump jacks, compression, submersible pumps, foaming and swabbing. Each of these technologies has applications in which they perform best. For instance, high gas to liquid ratio wells with high well pressure are best suited for plunger lift applications. High water flow rate wells are best suited for submersible pump applications.

A method for removing water from well bores is the use of foaming agents. The method is rapid, relatively inexpensive, and generally cost effective. Furthermore, only a lubricator or small pump is required for the treatment. Foaming agents form a light foam column when properly mixed with the water or brine in the well bore and agitated by even a small amount of gas from the formation. This lightened column is lifted from the well by gas pressure that is too low to lift a column of water. Furthermore, the foam is rigid. Capturing gas in the form of small bubbles prevents the gas from bypassing water in large casings.

Disadvantages of using foam for deliquification include the difficulty in tailoring the treatment to different wells, changing well conditions, and treatment systems. The foaming tendency depends on the amount and type of well fluids, as well as the effectiveness of different surfactants with different well fluids. In addition, the surfactant may produce foam carryover or liquid emulsion problems. Depending on the complexity of the liquid loading condition, multiple treatments may be required to fully assess and remediate the condition.

In addition to deliquification treatments, other chemical treatments are used in association with many gas wells. Typically, the chemical provider reports to the well operator on the chemical provider's product's performance, but such reports may occur only monthly or even less frequently, as they are often dependent upon the provider actually visiting the well to check on its status. Well operators often do not personally monitor anything except basic well flow rate unless they are also on site.

### SUMMARY

The devices and methods described herein relate generally to the field of gas and oil wells. In particular, methods and systems for enhanced gas recovery, including automated processes and apparatus to assist in monitoring and treating gas wells during production, are described.

One embodiment is a skid, or pallet or other platform (collectively, “skid”), equipped with multiple injection pumps and monitoring equipment and utilizing software that can be utilized for both batch and continuous treatment of gas wells exhibiting liquid loading conditions. The skid typically operates in conjunction with existing gas well equipment and provides a means to both monitor and control treatments in an automated fashion. Generally, the skid contains equipment that utilizes sensors for monitoring the well flow pattern of gas, liquid, temperature and pressure. The software package that accompanies the skid is programmed to detect various “trigger points” in these and other measurements that indicate the presence of liquid loading conditions. In response to detection of these events, the skid will automatically initiate an appropriate treatment. Such treatments may comprise “shutting in” the well, applying a chemical treatment, waiting a specific period of time, and re-starting the well. Other treatments may also be applied by the skid in an automated fashion.

The skid can be used in association with offshore or on land chemical application programs in which multiple chemicals are injected from one location. The software package for this embodiment allows the operator to utilize the skid as a total chemical program monitoring tool. The system provides the operator with the ability to locally or remotely monitor chemical inventory, chemical injection rates, pump pressures, pump performance, and other relevant criteria. The system also provides the flexibility to change the program locally or remotely while also providing a local or remote monitoring program for efficiency and performance of each application. The skid can be operated in either local or remote and either manual or automated mode. Thus, treatments can be tailored or overridden from afar, without requiring an individual to actually visit the well itself. This is particularly advantageous when the well is located in a remote location, such as offshore.

The described methods and systems provide an ability to monitor and control a variety of features and to provide tailored chemical injections to a gas well in order to counteract conditions such as liquid loading. The described methods and systems described herein allow a user to monitor chemical inventory, injection rates, and pressures, in addition to well performance.

### BRIEF DESCRIPTION OF DRAWINGS

FIG. 1 shows a schematic of the components of a skid, with a PLC, in connection with a typical gas well.

FIG. 2 shows an idealized apparatus that allows a user to monitor and control various aspects of a gas well and an alarm summary for same.

FIG. 3 shows an idealized apparatus that allows a user to monitor and control administration of a foaming agent to a gas well as part of a deliquification process and an alarm summary for same.

FIG. 4 shows an idealized apparatus that allows a user to monitor and control the administration of a defoaming agent to a gas well as part of a deliquification process and an alarm summary for same.

FIG. 5 shows an idealized apparatus that allows a user to monitor and control the administration of a water flush to a gas well as part of a deliquification process and an alarm summary for same.

FIG. 6 shows a chart displaying an example summary of the performance of the gas well as measured by the skid and the PLC.

FIG. 7 shows a schematic for an embodiment of a skid.

FIG. 8 shows a schematic for another embodiment of a skid.

### DETAILED DESCRIPTION OF PREFERRED EMBODIMENTS

In one preferred embodiment, the monitoring equipment and injection pumps are combined into one apparatus that can be used directly in conjunction with a producing gas well and software package.

An example of an apparatus that can carry out the described automation of the monitoring and treatment processes is a skid. A skid is literally a steel frame on which equipment is mounted so the equipment and steel frame can be easily moved with cranes and on flatbed trucks. However, industry common usage refers to the combination of the steel frame and the equipment it carries a “skid.” That usage is adopted here. Any combination and configuration of the equipment described herein appropriate for use in the oil/gas field environment to produce the results described herein is referred to herein as a skid.

The described skid can facilitate the monitoring and treatment of gas wells exhibiting liquid loading conditions through automated batch or continuous treatment, as well as the monitoring and treatment of other gas well conditions. For example, the skid may monitor gas flow, liquid flow, temperature and pressure of the flowing well. In some embodiments, the skid operates in conjunction with either offshore or onshore software and hardware safety processes. In some embodiments, the skid may utilize existing gas well and flowline equipment to carry out the described monitoring and treatment. The skid should be flexible enough to utilize chemical injection pumps, including either electric or pneumatic pumps.

An example skid includes a programmable logic controller (“PLC”), which can be a computer, one or more well performance monitoring devices such as gas or liquid flow meters in communication with the PLC, one or more tanks containing chemical or fluid, one or more chemical or fluid injection pumps having controllable valves in communication with the PLC, one or more well control devices that can be monitored and controlled such as intermitters, flowline wing valves, and inline chokes also in communication with the PLC, and a software package used by the PLC. In preferred embodiments, each injection pump operates independently of the others. Each injection pump is preferably equipped with its own controllable valve and its own separate feed and chemical tank, as well as its own separate injection point into the well. Associated with each injection pump on the example skid is its own pressure and metering devices to turn the pumps on and off. All of the pumps are managed independently by the PLC. In a preferred embodiment, the skid is equipped with six small continuous injection pumps.

In certain embodiments, multiple skids work on multiple producing gas wells. One central server may be employed to control and monitor the skids simultaneously, and to provide access to users to each skid's PLC and software. For example, a user wishing to monitor one particular skid in the system can simply visit an internet-based link and utilize an access code to view that skid's information. Different users may be limited to data from or control of limited different devices or functions.

The software package can be any appropriate software package used with gas wells to control and monitor performance and chemical injections. For example, a software package from General Electric (Fairfield, Conn.) can be used. In that case, the software is supported by the provider, so software problems can be directed to that company. The software package controls automation of the monitoring and treatment performed on the skid, as well as monitoring the inventory of chemicals and liquids stored in tanks for use in various well treatments. Preferably, the software package interfaces with a server and includes a server memory backup. This will allow a user to access the data from the PLC via the server and an internet or satellite connection to view production history and treatment results.

In one embodiment, the skid contains at least one set of well performance monitoring devices and chemical injection pumps specifically directed toward monitoring when and if the well becomes liquid loaded and administering a chemical treatment to deliquify the well. The well performance monitoring devices may monitor various factors, including gas flow rate. For example, using the software, the PLC may be programmed to detect a minimum acceptable level of gas flow rate at the well. For example, a well having no liquid loading may flow at 500 MFCD. The minimum rate for that well can, for example, be set at 300 MFCD for three hours. If the well's flow rate is measured at less than 300 MFCD for over three hours, then a “trigger point” is crossed and the well is considered to be liquid loaded. This is the point at which treatment is initiated. The minimum flow rate trigger point will vary from well to well, depending on its typical production levels and other factors. Those in the gas production field will understand how to calculate an appropriate minimum flow rate using available data on the well and its production history. In other embodiments, other production monitoring criteria and devices may be used to determine the trigger point at which the well is considered to be liquid loaded, such as liquid flow rate and pressure. Temperature and pressure trigger points may be set for sensors located at one or more points in the well equipment associated with the well

In one example, once the trigger point is reached indicating liquid loading, the PLC sends a signal to associated well control devices, such as any appropriate in line valves, instructing that the well be “shut in.” “Shut in” occurs when the valves on a well have been closed so the well stops producing temporarily. This can be accomplished by sending a signal to existing automatic flowline wing valves and inline chokes, flowline spool equipment, or to an intermitter. An intermitter is a manual or automated flowline valve control with appropriate safety controls to allow for automated shut in and restart. Commercially available intermitters include those made by Ferguson Beauregard (Tyler, Tex.). Once the shut-in signal is received, the appropriate well control devices then shut-in the gas well for deliquification treatment.

Once the well has been shut in, the PLC then sends a signal to the controllable solenoid valves on the chemical injection pumps instructing them to pump the appropriate amount of foamer or other substance into the well bore at an injection point. In one particular example, the chemical injection pumps first pump a “pre-wet,” or water, into the well bore. The volume of the pre-wet will vary but can be determined by a person of ordinary skill in the art based on the characteristics of the well and the degree of liquid loading. Once the pre-wet is administered, the PLC again sends a signal to the solenoid valves to switch from injecting the pre-wet to injecting the chemical, which can be any foaming agent. Suitable foamers include non-ionic, anionic, cationic, amphoteric, and other chemical foamers, or mixtures thereof. Some foamers are available with additional components, such as scale inhibitors and corrosion inhibitors. An appropriate foamer can be selected according to experience with subject well. Commercially available foamers include those made by MultiChem Group, LLC (Sonora, Tex.). The chemical agent is injected in a predetermined volume, which can be determined based on the characteristics of the well and the degree of liquid loading. Upon complete of foamer injection and completion of a wasting period, if any, the PLC sends a signal directing the pumps to inject a “flush,” which is also a predetermined amount of additional water. In some circumstances, an additional amount of defoamer chemical may be applied. Over time, the exact amounts and characteristics of the pre-wet, the chemical injection, the flush, and the defoamer, as well as any other applications, can be altered as it is determined which combinations and amounts of treatments are most effective on particular wells. One of the benefits of the current systems and methods is the ability to constantly change the treatments to best suit the application.

In this example, after application of the flush, the PLC then directs the well control devices to hold the well in a shut in state for a predetermined amount of time to allow the chemical treatment to fall to the bottom of the well bore and disperse through the standing fluid level. The amount of time will depend upon the expected fall rate of the chemical treatment. For example, one chemical treatment in a particular well may have a fall rate of 2000 ft/hr. If the well is 10,000 feet deep, then it is shut in for approximately 5 hours to allow the chemical treatment to penetrate. Weighted foamers are also useable with this method to allow faster penetration once the foamer gets to the fluid level.

After the preset period of time passes to allow the chemical treatment to take effect, the PLC then sends a signal to the appropriate in line valve to begin re-opening the well to normal flow conditions. The re-opening is a slow process in order to prevent over-running the system with gas flow, produced fluids, and pressure. Once the well is fully re-opened, the skid returns to a monitoring mode in which it uses well performance monitoring devices to monitor various factors, including gas flow rate. Presumably the well will no longer be liquid loaded and will produce a greater rate than prior to treatment, so the entire process will begin again, the PLC monitors well performance and detects when and if the several predetermined trigger points are crossed. When this occurs, the shut in and treatment phase begins again.

This type of chemical treatment is known as a batch or cyclical application, in which chemicals are applied periodically in response to the detection of various conditions. The skid is capable of monitoring and treating other well performance conditions, in addition to liquid loading. Thus, in preferred embodiments, the skid contains pumps and equipment for both batch applications and continuous applications. Multiple chemical treatments can be coordinated, and monitored, using a single skid. For example, if a continuous pump is continuously applying a demulsifier treatment, then appropriate well performance monitoring devices will also be monitoring basic sediment and water both upstream and downstream of the injection point. For a scale inhibition treatment, the skid will monitor calcium and total hardness levels upstream and downstream of the injection point. For paraffin inhibition, the paraffin deposition will be monitored downstream of the injection point. If the skid is continuously pumping a corrosion inhibitor, then the pitting rate or mils per year of penetration (“MPY”) will be monitored downstream of the injection point. For water clarification treatment, the skid will monitor oil in water (“OIW”) upstream and downstream of the injection point. If the skid is continuously pumping a H₂S scavenger, then the H₂S ppm will be monitored upstream and downstream of the injection point. Any chemical treatment that can be applied to a gas well and whose effects can be monitored through the use of a PLC and monitoring equipment can be administered through use of the skid.

Throughout the process, the skid monitors chemical inventories, chemical injection rates, and chemical injection pressures in addition to well flow rate, temperature, and pressure. The connection to the PLC and the server will also allow a user to monitor and make adjustments to the chemical injection rates and to view and download reports from the PLC from a remote location via the internet, a satellite link up, or any other suitable means.

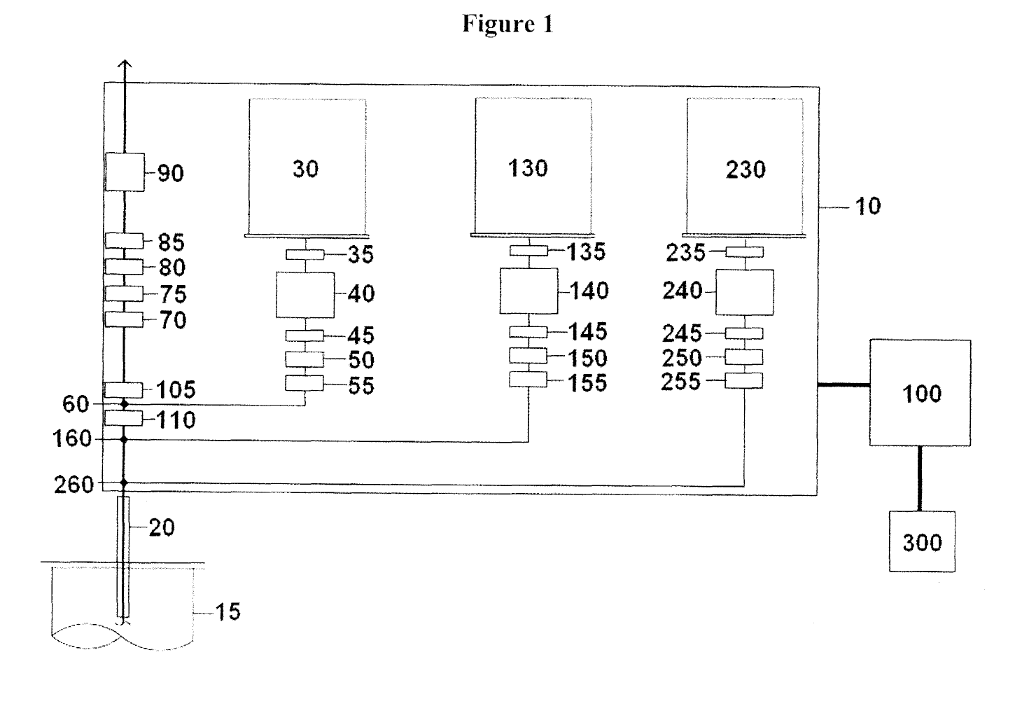

FIG. 1 shows a general schematic of how one example of an enhanced gas recovery skid 10 might appear. The skid 10 utilizes a variety of chemical or fluid injection tanks 30, 130, 230 and numerous valves and sensors, all in communication with a programmable logic controller (“PLC”) 100. The skid 10 is intended to assist in improving performance of typical gas well 15 having well bore 20. In some embodiments, all equipment needed for well performance enhancement and control is physically located on the skid. In other embodiment, not every structure illustrated as being within the skid 10 is necessarily physically located on the skid. Rather, the structures illustrated as being within the skid 10 are in communication with or coupled to the skid 10 and the PLC 100. For example, chemical or fluid tanks 30, 130, and 230 may not be physically located on the skid 10, but they are considered to be part of the overall skid and enhanced gas recovery system. In addition, while an exemplary skid is illustrated to have only three chemical tanks, any number of chemical tanks can be used. Chemical or fluid tanks 30, 130, and 230 can contain foaming agents, water, defoamers, or any chemical treatment that might be applied to a gas well. The chemical or fluid tanks 30, 130, and 230 are equipped with chemical control shutdown valves 35, 135, and 235 that control the passage of fluid toward chemical injection pumps 40, 140, and 240. If the PLC 100 instructs the shutdown valves 35, 135, and 235 to open and the pumps 40, 140, and 240 to proceed with the chemical injection, the chemical or fluid will then pass through flow control values 45, 145, and 245, which control the rate of flow of the chemical or fluid.

The chemical or fluid that will be injected, pursuant to instructions from the PLC 100, passes through pressure sensors 50, 150, and 250 and flow meters 55, 155, and 255. These sensors communicate with the PLC 100 to assist in controlling the release of the chemical or fluid from the tanks 30, 130, and 230. The chemicals or fluids enter the gas well flow line at various injection points 60, 160, and 260. Again, although these injection points may be shown to be within the skid 10, they are not physically located on the skid, but rather are controlled by the skid 10 and the PLC 100. As the gas passes out of the well 15 and the well bore 20, it encounters these injection points 60, 160, and 260 and becomes treated with the various chemicals or fluids. The gas will also pass through additional sensors after leaving the well bore 20, including for example a gas flow rate meter 70, a pressure sensor 75, a liquid flow rate meter 80, and a temperature sensor 85. The meters and sensors are controlled by and in communication with the skid 10 and the PLC 100.

In one example illustrated in FIG. 1, chemical tank 230 may be a tank containing a chemical or fluid to be used in a batch application for deliquification of the well 15. If the gas flow rate meter 70 communicates to the skid 10 and the PLC 100 that a minimum gas flow rate trigger point has been reached, then the PLC 100 will communicate with a flowline valve control 90 that will then initiate a shut in phase for the well. Then, the PLC will direct the chemical control shutdown valve 235 to release the appropriate chemical or fluid from chemical tank 230, such as water or a foaming agent. The injection pump 240 will begin pumping the chemical or fluid through flow control valve 245, which are both also in communication with PLC 100 to ensure the appropriate amount of chemical or fluid is released. The chemical or fluid will enter the well line at injection point 260, which is preferably at a position that will cause the chemical or fluid to physically fall into the well bore 20. After a period of shut in, and possibly the addition of other treatments of water or chemicals, such as defoaming agents, the PLC will direct the flowline valve control 90 to reopen the well 15.

In another example illustrated in FIG. 1, chemical tank 30 may be a tank containing a chemical for demulsification. This chemical is typically applied on a continuous basis while the well 15 is flowing. In this example, the skid 10 also incorporates and controls a basic sediment and water sensor 110 that is upstream of the injection point 60 and a basic sediment and water sensor 105 that is downstream of the injection point 60. The measurements from the sensors 110 and 105 are relayed to the skid 10 and the PLC 100 to determine the appropriate amount of demulsification treatment to be released from chemical tank 30. In other examples, there may be many more sensors located upstream and downstream of the various injection points.

Also as shown in FIG. 1, the skid 10 and the PLC 100 can be in communication with a central server 300. The central server 300 can be in communication with many other skids and PLC simultaneously. The central server 300 can also be accessed remotely by other users via an internet connection or satellite connection. By accessing the central server 300, users can also access the data, measurements, and reports that are generated by skid 10 and PLC 100, as well as any other skids and PLCs.

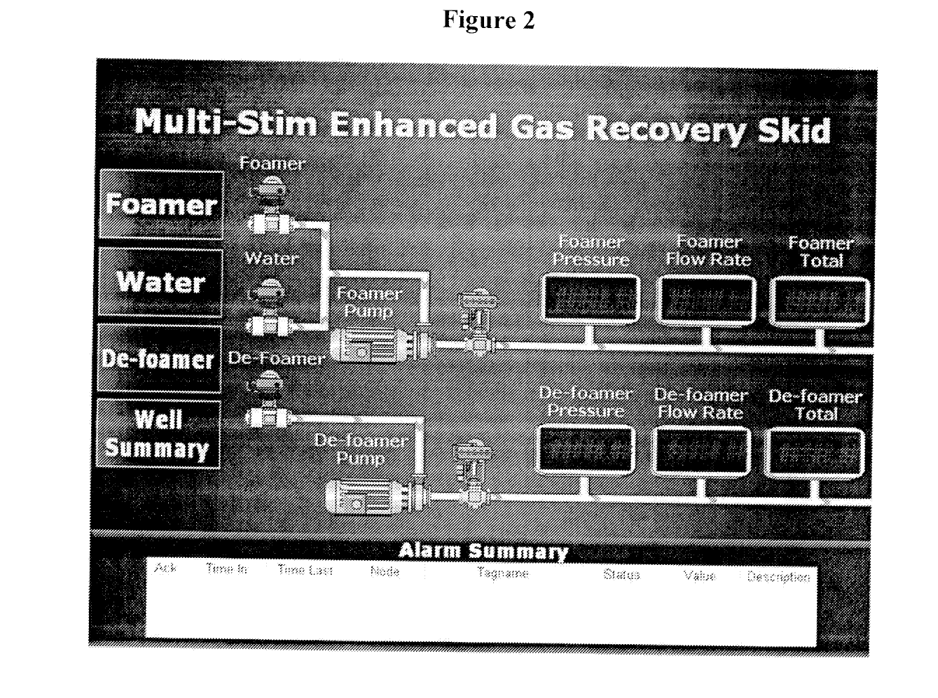

FIGS. 2-6 show various computer screen images visible to a user who accesses the central server 300 to view information about a particular well. For example, FIG. 2 shows a screen that a user could access to view an overview of at least some of the parts of the skid responsible for deliquification treatments. At the bottom of the screen, the past alarms that have occurred when the skid has sensed the passing of a “trigger point” and initiated a deliquification treatment are displayed. The boxes labeled Foamer Pressure, Foamer Flow Rate, Foamer Total, De-foamer Pressure, De-foamer Flow Rate, and De-foamer Total display numbers representing real time measurements of each of these criteria. Thus, the user views this information as these conditions are occurring.

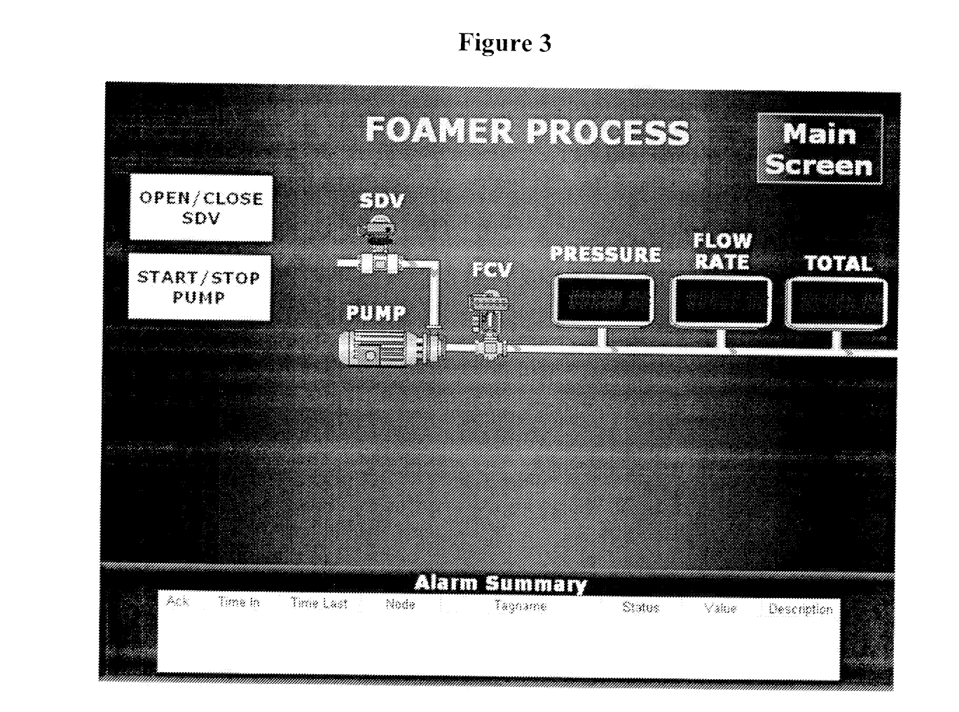

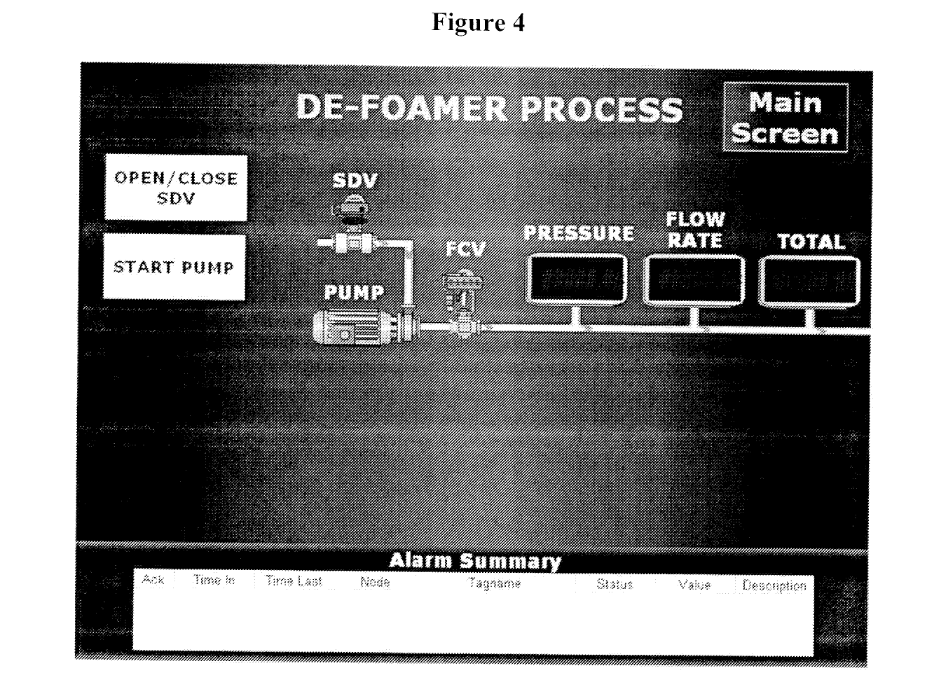

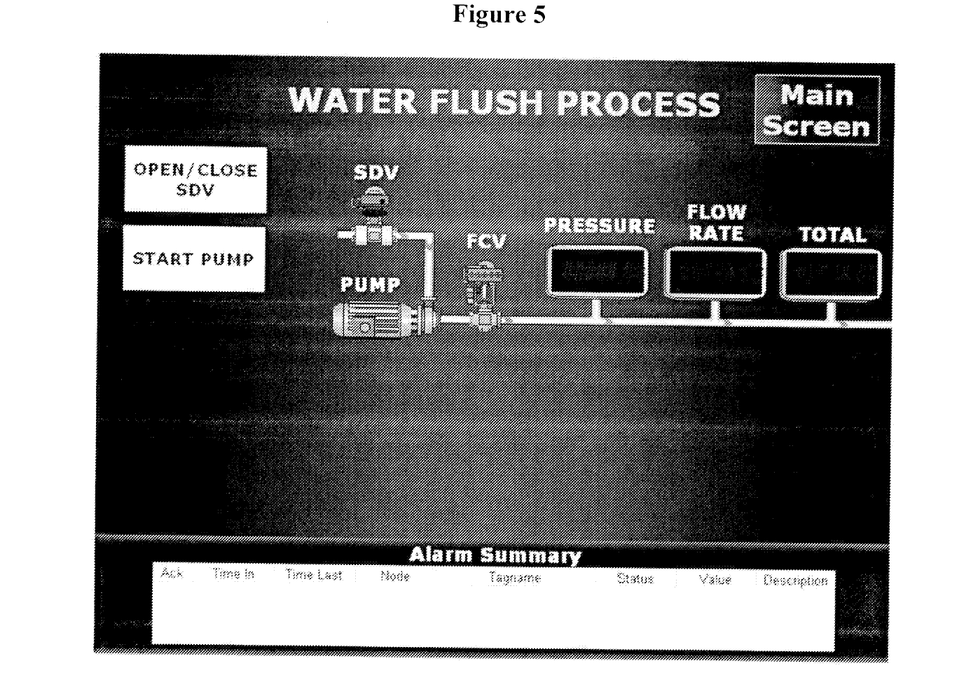

By selecting the button that says “Foamer” in the left hand side of the screen shown in FIG. 2, the user is taken to the screen shown in FIG. 3. FIG. 3 shows the “Foamer Process” detail screen, which again displays information on any past alarms and shows the real time measurements of certain well characteristics such as Pressure, Flow rate, and Total foamer. Also shown in FIG. 3 are buttons with the commands “Open/Close SDV” and “Start/Stop Pump.” Using these buttons, the user can control the foamer process by opening or closing the shutdown valve (“SDV”) for the chemical tank and starting or stopping the pump. FIGS. 4 and 5 show computer screens similar to what is shown in FIG. 3. FIGS. 4 and 5 show the screens that would be encountered if a user selected the “De-foamer” and “Water” buttons on the screen shown in FIG. 2. These screens also allow the user to view real time measurements of the defoamer process and the water flush process as they are occurring, and also provides buttons the user can select to manually control the application and timing of these treatments.

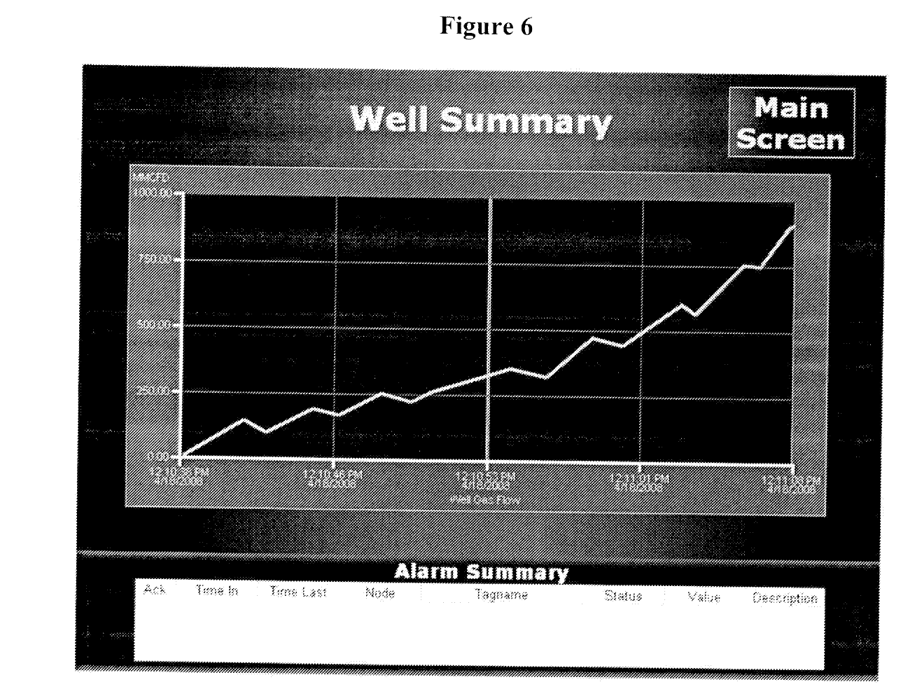

FIG. 6 shows a screen shot of a well summary that can be accessed if a user clicks on the “Well Summary” button on the screen shown in FIG. 2. The well summary shows the past performance of the well, in this case showing production rate in millions of cubic feet per day (“MMCFD”). This screen will also show a summary of past alarms encountered by the skid while monitoring and treating the well.

A variety of different software packages having different features, interfaces, and formats could be used in association with the skid and its PLC. The software package allows a user to access a skid remotely, allows real time monitoring of a variety of measurements taken by the skid, and allows a user to manually stop or start any of the treatments controlled by the skid.

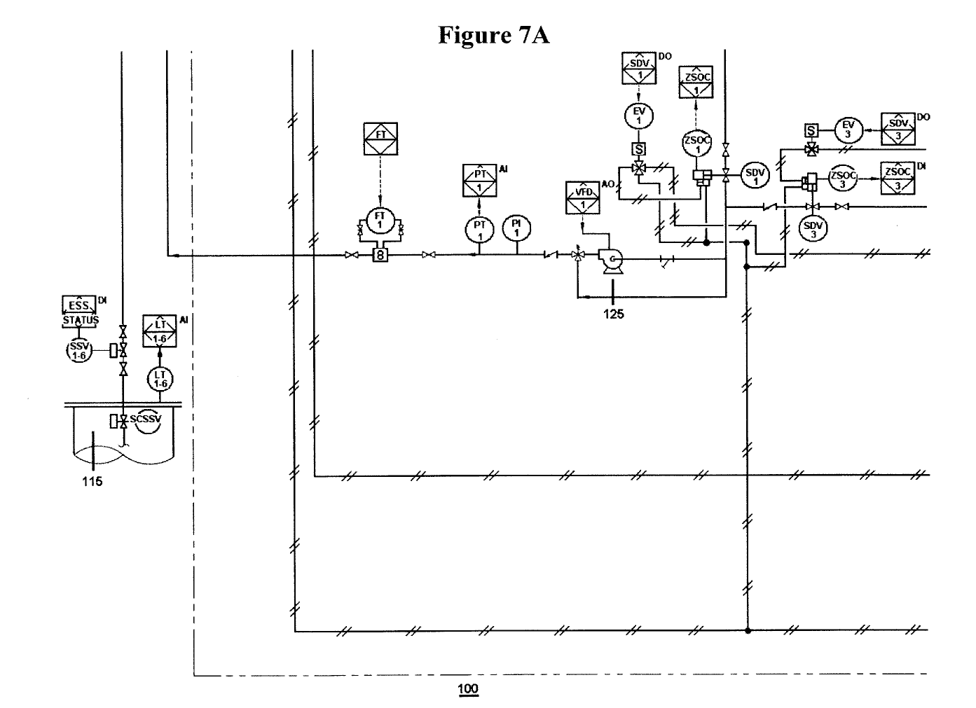

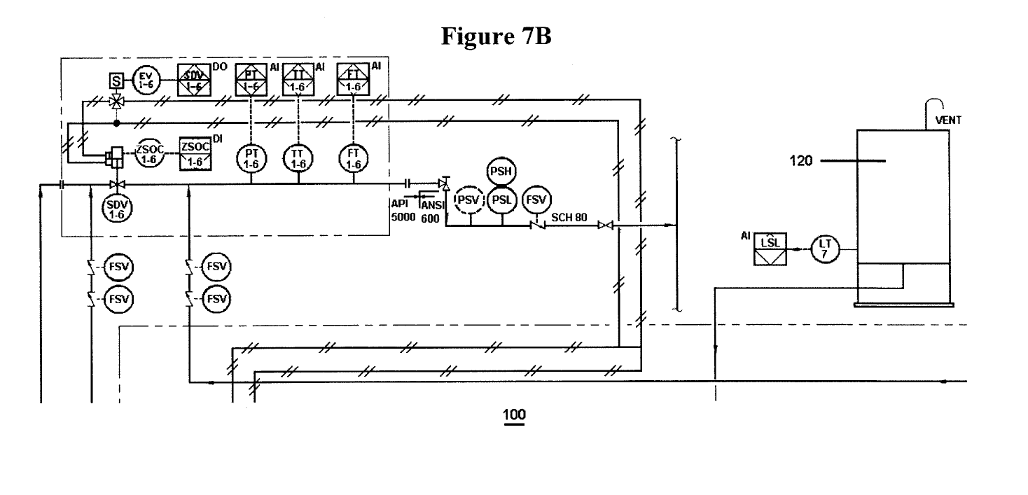

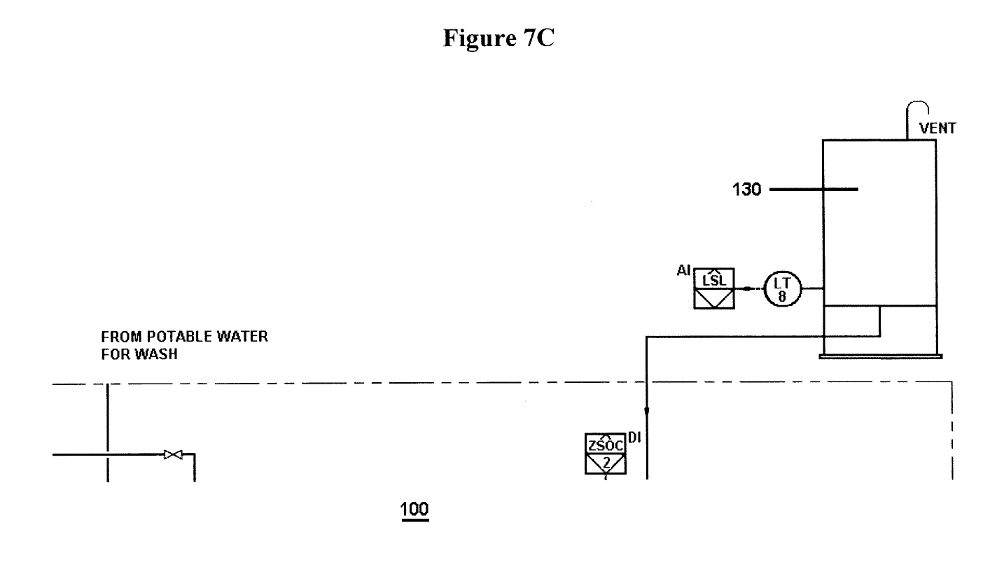

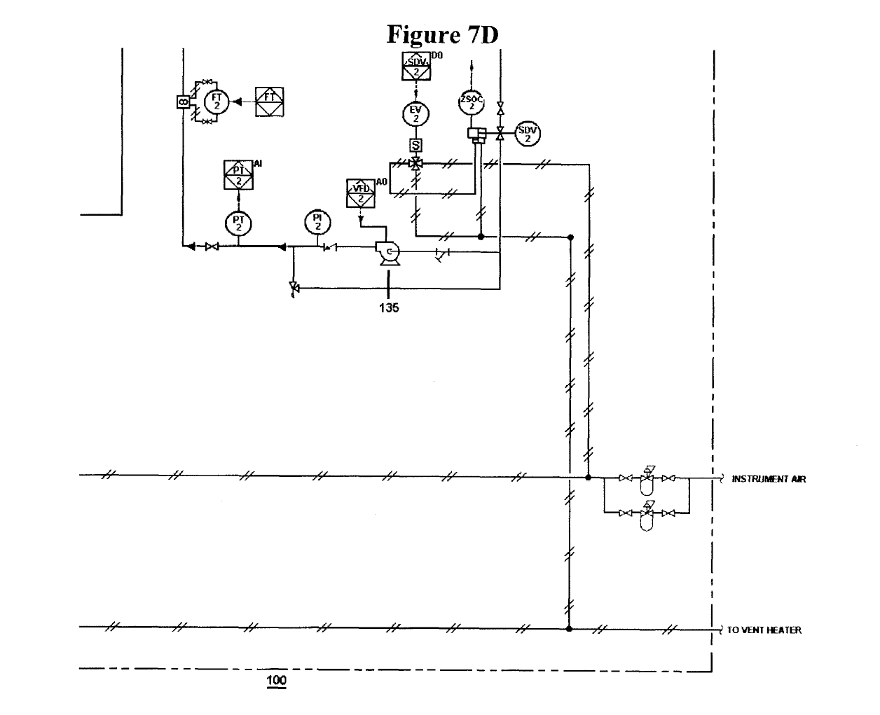

FIG. 7 shows a schematic of a preferred embodiment of a skid 100. Typical schematic symbols are used. The electric skid 100 is intended to assist in improving performance of typical gas well 115. The skid 100 includes a foaming chemical tank 120, a foamer pump 125, a de-foaming chemical tank 130, and a defoamer pump 135.

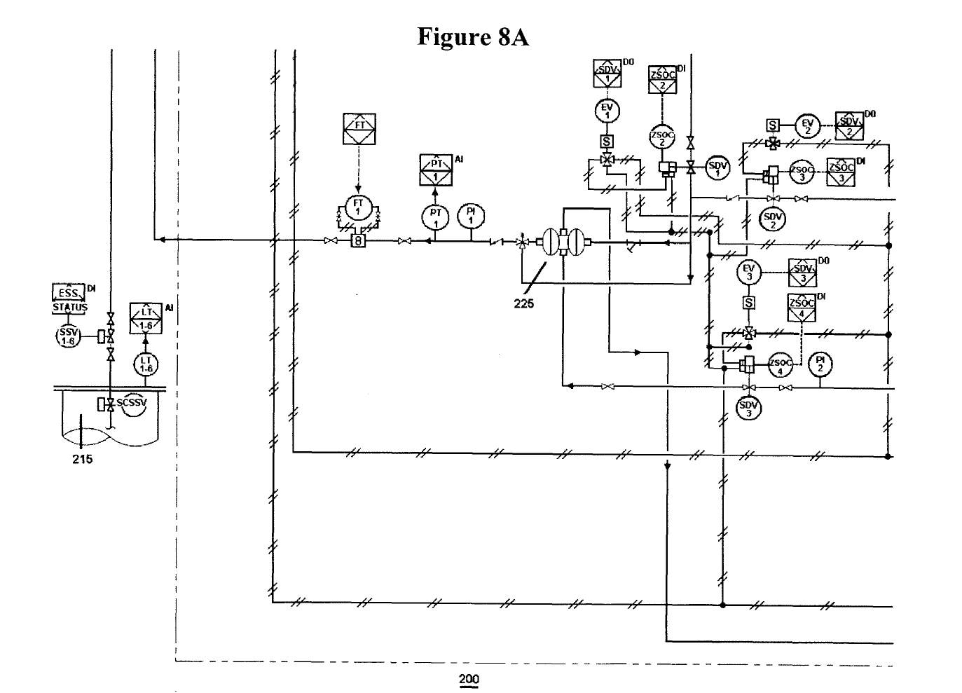

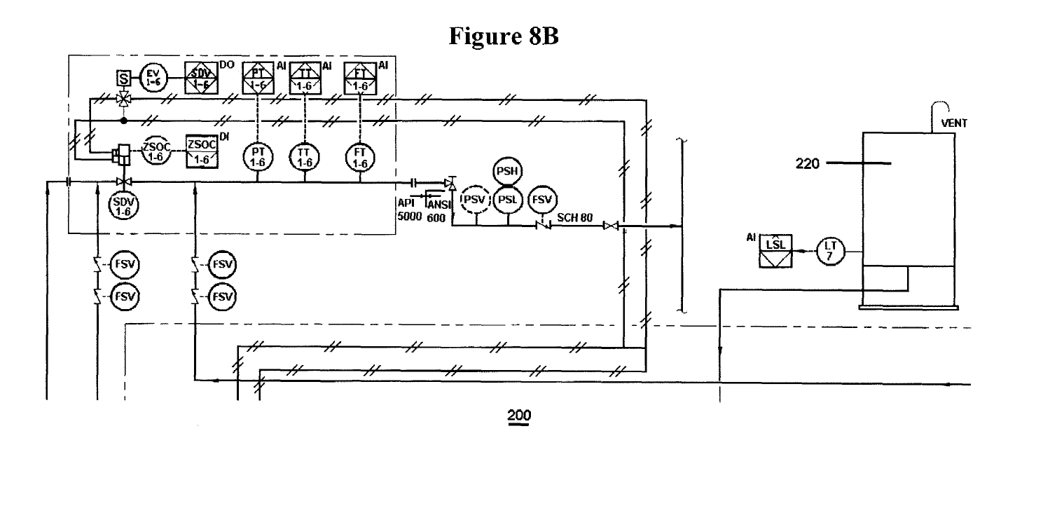

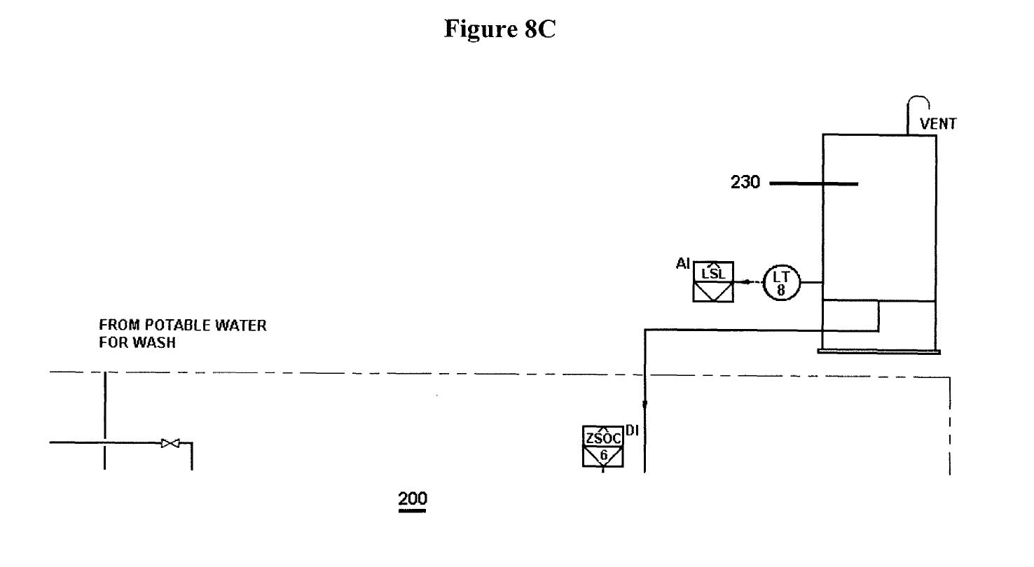

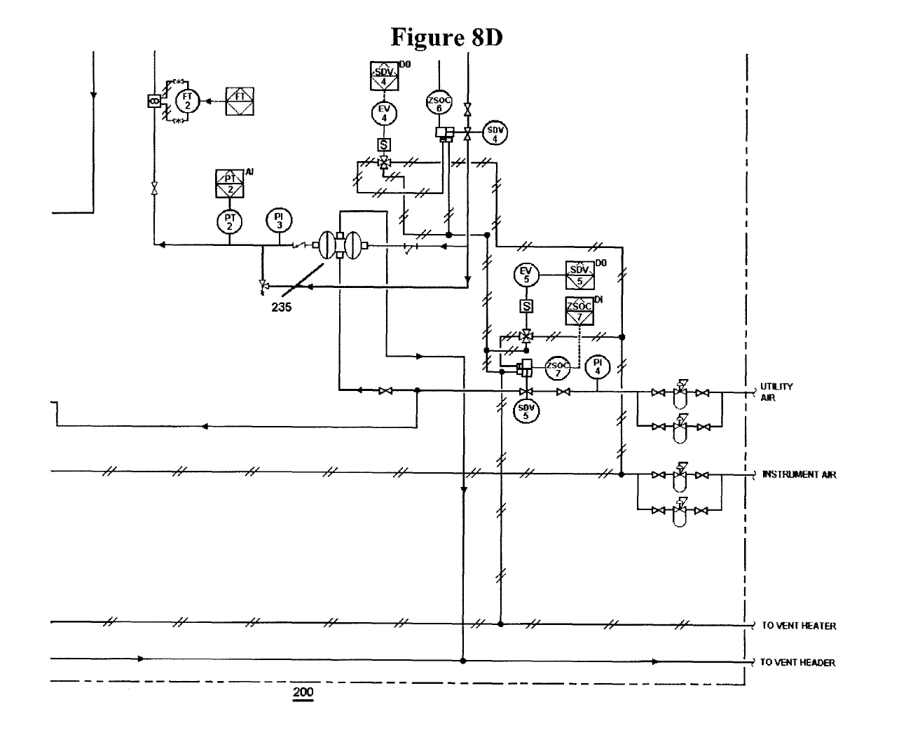

FIG. 8 shows a schematic of a preferred embodiment of a skid 200. Typical schematic symbols are used. The pneumatic skid 200 is intended to assist in improving performance of a typical gas well 215. The skid 200 includes a foaming chemical tank 220, a primary pump 225, a de-foaming chemical tank 230, and a defoamer pump 235.

The described automated batch/continuous treatment skid allows the monitoring and treatment of gas wells exhibiting liquid loading conditions. A preferred embodiment is designed to meet MMS, DNV, and ATEX certifications for its hardware and software components; operates in conjunction with offshore and onshore ESD software and hardware safety processes; utilizes existing automatic towline wiring valves/in-line chokes where possible for well “shut-in”/“re-open,” has flowline spool equipment where automatic wing valves/in-line chokes do not exist, and has the flexibility to utilize pneumatic or ATEX certified electric chemical injection pumps.

In a preferred embodiment, a unit monitors the well flow pattern of gas, liquid, temperature, and pressure and, through programmed trigger points, the software package recognizes a “liquid loading pattern” in the producing gas well and initiates a shut-in, liquid foaming agent batch application, dispersion down time, and re-start of the well. The software package automatically sends a signal to solenoid valves to switch from pre-wet to chemical and back to flush during each application, automatically initiates injection of liquid defoaming agent (where applicable); software package monitors chemical and flush inventory; and includes server memory backup and capability to pull production history and treatment results through multiple software programs, i.e., excel, access, etc.

A preferred embodiment has the flexibility to monitor both batch and continuous applications being performed from the skid; the capability to make changes to the treatment design and review skid/treatment performance from remote locations (operator to provide communication device, i.e., internet, satellite, etc.); and the capability to operate the skid in either manual or automatic mode. The monitoring tool is based upon the software and hardware packages of the skid. The software package allows the operator the option to utilize the skid as a total chemical program monitoring tool. The system provides the operator with the capability to monitor chemical inventory, chemical injection rates, pump pressures, pump performance, etc., and the flexibility to make changes to the program remotely while also providing a monitoring program for efficiency and performance of each application.

The described system, in one or more embodiments, is capable of providing treatment to make some gas wells flow at a greater rate than without such treatments and capable of making some gas wells economical to keep in production which would otherwise be uneconomic to keep in production. While an optimal rate of gas flow from a well could theoretically be obtained by maintaining trained personnel physically at the well site to continually monitor well conditions, well output, equipment conditions, inventory amounts, decide on treatments, initiate treatment, monitor treatment, monitor results, etc., the economics of maintaining such a person at some such gas wells for these purposes is often cost prohibitive. Additionally, some under-producing gas wells are at remote locations or in hostile environments, such as offshore. Accordingly, the system's ability to monitor several variables and to respond when trigger point measurements are obtained with predetermined responses designed to improve the well's flow rate to adjust treatment parameters responsive to results and monitor inventories makes some uneconomic wells into economic wells and makes some marginal wells into producing wells.

Because the system permits remote monitoring and remote control of the system's responses to monitored measurements, the system permits optimization of a well treatment program to improve well flow rate and decrease the expense of injections into the well to achieve a favorable cost benefit improvement and performance from the well. In some embodiments, a local computer program may be employed to cause the local system to itself adjust treatment triggers and treatment types, quantities and timing responsive to monitored measurements over time. Local monitoring and remote reporting of inventories to a central location reduces the need for personnel to check on local inventories as often as would be needed in the absence of local monitoring and remote reporting of inventories. Local systems as described herein for treating wells can be linked together to facilitate communicating with a central location.

In an embodiment, the software package is capable of being set by the user to have at least one predetermined trigger point measurement from a well monitoring device, and capable of triggering an automated response to the predetermined trigger point measurement being measured, the automated response being capable of improving the flow of gas from the gas well. At least one trigger point measurement is a predetermined lowest acceptable level gas flow rate. The automated response is to shut the well in, inject a predetermined type of foamer into the well, wait a predetermined shut-in length of time for the foamer to settle into the well, reopen the well, and monitor the new gas flow rate from the well. The predetermined lowest level gas flow rate trigger point, the predetermined quantity of foamer, and the predetermined shut-in length of time can be remotely changed by the user.

Although the invention has been described with reference to specific embodiments, this description is not meant to be constructed in a limited sense. Various modifications of the disclosed embodiments, as well as alternative embodiments of the invention, will become apparent to persons skilled in the art upon reference to the description of the invention. It is, therefore, contemplated that the appended claims will cover such modifications that fall within the scope of the invention, or their equivalents

What is claimed is:

1. A system for monitoring and treating a gas well to enhance gas recovery from the well, comprising:
a programmable logic controller (“PLC”);
one or more well monitoring devices in communication with the PLC, the well monitoring devices being capable of monitoring the well, including at least monitoring gas flow from the well;
one or more injection pumps in communication with the PLC, the injection pumps being capable of injecting fluid into the well into gas or fluid flow from the well;
one or more tanks containing fluid connected to the injection pumps in communication with the PLC;
one or more well control devices connected to the well in communication with the PLC, at least one of the well control devices being capable of controlling gas or fluid flow from the well;
a software package installed on the PLC capable of collecting data from the well monitoring devices and the tanks, and communicating with the injection pumps and the well control devices;
a central server which is remote from the PLC and in communication with the PLC; and
a user connection interface associated with the central server that utilizes the software package and allows a user to access the central server and the PLC,
wherein the PLC receives and stores, data collected from the well monitoring devices, and wherein the data stored in the PLC can be accessed remotely by a user through the user connection interface and the central server, and wherein the user can remotely control the injection pumps, and the well control devices through the user connection interface and the central server.

2. The system of claim 1, wherein the software package is capable of being set by the user to have at least one predetermined trigger point measurement from a well monitoring device, and capable of triggering an automated response to the predetermined trigger point measurement being measured, the automated response being capable of improving the flow of gas from the gas well.

3. The system of claim 2, wherein the system is designed and constructed so at least one trigger point measurement is a predetermined lowest acceptable level gas flow rate and wherein at least one automated response is to shut the well in, inject a predetermined type of foamer into the well, wait a predetermined shut-in length of time for the foamer to settle into the well, reopen the well, and monitor the new gas flow rate from the well.

4. The system of claim 3 wherein the system is designed and constructed so the predetermined lowest level gas flow rate trigger point, the predetermined quantity of foamer to be injected into the well, and the predetermined shut-in length of time can be remotely changed by the user and so the user can remotely monitor the new gas flow rate from the well.

5. The system of claim 4, wherein the PLC, at least one injection pump, at least one tank, and the software package are located on a single skid, the skid being capable of being moved to and from the well as a single unit.

6. The system of claim 1, wherein the one or more well monitoring devices are one or more gas flow meters, liquid flow meters, pressure sensors, temperature sensors, or combinations thereof.

7. The system of claim 1, wherein the one or more injection pumps are one or more electric pumps, one or more pneumatic pumps, or combinations thereof.

8. The system of claim 1, wherein the one or more tanks are one or more chemical tanks, one or more water tanks, or combinations thereof.

9. The system of claim 1, wherein the one or more tanks further comprise one or more controllable valves in communication with the PLC.

10. The system of claim 1, wherein the one or more tanks contain water, foaming agent, defoaming agent, demulsifier agent, scale inhibition agent, paraffin inhibition agent, corrosion inhibition agent, water clarification agent, H₂S scavenging agent, or combinations thereof.

11. The system of claim 1, wherein the one or more well control devices are one or more intermitters, one or more flowline wing valves, one or more inline chokes, flowline spool equipment, or combinations thereof.

12. The system of claim 1, wherein the one or more well control devices are capable of closing the well to stop production.

13. The system of claim 1, wherein the user connection interface utilizes an internet connection or a satellite connection.

14. The system of claim 1, further comprising one or more treatment monitoring devices, wherein the one or more treatment monitoring devices are one or more meters or sensors.

15. The system of claim 1, wherein the PLC, the software package, the central server, and the user connection interface allow the system to be operated either through automation or manually by a user.

16. The system of claim 1, further comprising a skid configured to be connectable to a gas well, wherein the PLC, one or more well monitoring devices, and one or more tanks are physically located on the skid.

17. A system for deliquification of a gas well to enhance gas recovery from the well, comprising:
a programmable logic controller (“PLC”);
one or more well monitoring devices in communication with the PLC, the well monitoring devices being capable of monitoring the well, including at least monitoring gas flow from the well;
a plurality of injection pumps in communication with the PLC, the injection pumps being capable of injecting fluid into the well into gas or fluid flow from the well;
a plurality of tanks containing fluid connected to the injection pumps in communication with the PLC, wherein the plurality of tanks includes tanks containing water, tanks containing foaming agent, tanks containing defoaming agent, or combinations thereof;
one or more well control devices connected to the well in communication with the PLC, wherein the one or more well control devices are capable of closing the well to stop production, at leas one of the well control devices being capable of controlling gas or fluid flow from the well;
a software package installed on the PLC that is capable of collecting data from the well monitoring devices and the tanks, and communicating with the injection pumps and the well control devices;
a central server which is remote from the PLC and in communication with the PLC; and
a user connection interface associated with the central server that utilizes the software package and allows a user to access the central server and the PLC,
wherein the PLC activates and deactivates the one or more well control devices to enable closing or opening of the well in response to detection of a signal from the one or more well monitoring devices, wherein the PLC activates and deactivates the injection pumps to enable release or non-release of fluid from at least one of the tanks, wherein the PLC receives and stores data collected from the well monitoring devices, the injection pumps, the tanks, and the well control devices, wherein the data stored in the PLC can be accessed remotely by a user through the user connection interface and the server, and wherein the PLC, the software package, the central server, and the user connection interface allow the system to be operated either through automation or manually by a user.

18. The system of claim 13, wherein the one or more well monitoring devices are one or more gas flow meters, liquid flow meters, pressure sensors, temperature sensors, or combinations thereof.

19. The system of claim 13, wherein the one or more injection pumps are one or more electric pumps, one or more pneumatic pumps, or combinations thereof.

20. The system of claim 13, wherein the one or more tanks further comprise one or more controllable valves in communication with the PLC.

21. The system of claim 13, wherein the one or more well control devices are one or more intermitters, one or more flowline wing valves, one or more inline chokes, flowline spool equipment, or combinations thereof.

22. The system of claim 13, wherein the user connection interface utilizes an internet connection or a satellite connection.

23. The system of claim 13, further comprising one or more treatment monitoring devices, wherein the one or more treatment monitoring devices are one or more meters or sensors.

24. The system of claim 13, further comprising a skid configured to be connectable to a gas well, wherein the PLC, one or more well monitoring devices, and one or more tanks are physically located on the skid.
